(19) United States
(12) Patent Application Publication
(10) Pub. No.: US 2014/0279062 A1
(43) Pub. Date: Sep. 18, 2014

(54) CONSULTANT TOOL FOR DIRECT SELLING

(71) Applicant: RODAN & FIELDS, LLC, San Francisco, CA (US)

(72) Inventors: Eric M. Hackman, Sacramento, CA (US); John H. Barrera, Fairfield, CA (US); Oran Arazi-Gamliel, Hadera (IL)

(73) Assignee: RODAN & FIELDS, LLC, San Francisco, CA (US)

(21) Appl. No.: 13/842,720

(22) Filed: Mar. 15, 2013

(51) Int. Cl. G06Q 30/02

(52) U.S. Cl. CPC G06Q 30/0276
USPC 705/14.72

(57) ABSTRACT

A software application running on a mobile electronic computing device includes receiving and storing contact information for a plurality of business contacts. Editable call scripts and editable email templates are displayed. One or more edited or new call scripts or one or more edited or new email templates are sent to a third party. Communications are initiated to one or more of the business contacts using one or more editable, edited or new call scripts or one or more editable, edited or new email templates. A record of the communications is sent to a server computer.

### BACKGROUND

Direct selling is a sale of a consumer product or service, person to person, away from a fixed retail location. Direct selling is typically marketed through independent sales representatives, commonly known as consultants. Direct selling is a growing aspect of consumer product marketing, permitting consultants to form independent businesses and earn money on a full-time or part-time basis.

Some companies employ a direct sales force as a primary means of marketing their products. For these companies, one aspect of direct selling is recruitment of new customers to buy their products and new consultants to sell their products. For many of these companies, one of the main goals of existing consultants is to increase the volume of products that are sold by means of recruiting new customers as well as new consultants to sell those products. Recruitment of new customers and consultants is often difficult, sometimes requiring techniques such as cold calling, whereby consultants may need to call people they do not know or do not know very well. Many consultants may not be proficient in or comfortable with using techniques such as cold calling.

### SUMMARY

Embodiments of the disclosure are directed to a computer-readable storage memory. The computer-readable storage memory comprises instructions that, when executed by a by a mobile electronic computing device, cause the mobile electronic computing device to: receive and store contact information for a plurality of business contacts; display one or more editable call scripts and one or more editable email templates; receive edits to one or more of the call scripts or one or more of the email templates or receive one or more new call scripts or email templates; send the one or more edited or new call scripts or the one or more edited or new email templates to a third party; initiate communications to one or more of the business contacts using the one or more editable, edited or new call scripts or the one or more editable, edited or new email templates; and send a record of the communications to a server computer.

In another aspect, a method implemented on a server computer comprises: on the server computer, receiving business contact information from a mobile electronic computing device; receiving, from the mobile electronic computing device, information of call scripts created and email templates created on the mobile electronic computing device; receiving, from the mobile electronic computing device, information of telephone calls made, email messages sent, and text messages sent to business contracts from the mobile electronic computing device; and compiling one or more activity reports of the business contact information, call scripts created, email templates created, telephone calls made, email messages sent, and text messages sent to business contacts from the mobile electronic computing device.

In yet another aspect, a method implemented in a software application running on a mobile electronic computing device comprises: on the mobile electronic computing device, receiving and storing contact information for a plurality of business contacts; displaying one or more editable call scripts and one or more editable email templates; receiving edits to one or more of the call scripts or one or more of the email templates or receiving one or more new call scripts or email templates; sending the one or more edited or new call scripts or the one or more edited or new email templates to a third party; initiating communications to one or more of the business contacts using the one or more editable, edited or new call scripts or the one or more editable, edited or new email templates; and sending a record of the communications to a server computer.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports a consultant tool software application on a mobile electronic device.

FIG. 2 shows an example sign-in screen for a mobile electronic device of FIG. 1.

FIG. 3 shows an example home screen for the mobile electronic device of FIG. 2.

FIG. 4 shows an example dashboard screen for the mobile electronic device of FIG. 2.

FIG. 5 shows an example build screen for the mobile electronic device of FIG. 2.

FIG. 6 shows an example build screen for selecting a source from which to import contacts for the mobile electronic device of FIG. 2.

FIG. 7 shows an example import contacts screen for the mobile electronic device of FIG. 2.

FIG. 8 shows an example connect screen for the mobile electronic device of FIG. 2.

FIG. 9 shows an example contact filter screen for the mobile electronic device of FIG. 2.

FIG. 10 show an example contact detail screen for the mobile electronic device of FIG. 2.

FIG. 11 shows an example call preparation screen for the mobile electronic device of FIG. 2.

FIG. 12 shows another example call preparation screen for the mobile electronic device of FIG. 2.

FIG. 13 shows an example email template screen for the mobile electronic device of FIG. 2.

FIG. 14 shows an example planning calendar screen for the mobile electronic device of FIG. 2.

FIG. 15 shows an example list view of the planning calendar screen of FIG. 14.

FIG. 16 shows an example training screen for the mobile electronic device of FIG. 2.

FIG. 17 shows an example call script editing screen for the mobile electronic device of FIG. 2.

FIG. 18 shows an example create my own screen for the mobile electronic device of FIG. 2.

FIG. 19 shows another script editing screen for the mobile electronic device of FIG. 2.

FIG. 20 shows a voice recording screen for the mobile electronic device of FIG. 2.

FIG. 21 shows an example activity report that may run on the web server computer of FIG. 1.

FIG. 22 shows an example data schema for the consultant tool.

FIG. 23 shows example physical components of the mobile electronic devices of FIG. 1.

### DETAILED DESCRIPTION

The present disclosure is directed to a software application for a mobile electronic device that may help in the recruitment of new consultants for direct selling. The software application includes tools for building contacts, connecting with contacts, planning and training. The software application may be downloaded from a server computer to a smart telephone such as an iPhone. Contact and other information from the smart telephone is synchronized with one or more server computers in an Internet cloud.

The software application may be used as an aid to help existing consultants recruit new consultants. Call script templates are provided that may help consultants practice pitches to prospective new consultants. The call script templates may be edited to personalize the call script. The software application also permits voice recording of call scripts on the smart telephone so that a consultant can play back the recordings and hear how they sound. Other voice recordings are possible. Editable email templates are also provided as an aid to the consultants. The voice recordings, edited call scripts and edited email templates may be shared with other consultants, with a consultant's sponsor to obtain feedback that the consultant may use, with consultants in the user's organization to provide examples for training and guidance or with anyone else. In this disclosure, the other consultants and consultant's sponsors may be referred to as third parties.

The software application also maintains a history of user activities. A history is updated for each call script or email template that is edited, for each voice recording that is made, for each telephone call made and for each email sent. The history may also be updated for other activities, for example for scheduling events or creating contacts. The history permits a consultant to easily look up a status of communication with prospective consultants or prospective sales contacts. The history is both stored on the smart telephone and uploaded to the Internet cloud. History events and statistics uploaded to the Internet cloud permit activity reports to be generated that provide a means to evaluate consultant performance. In this disclosure, the software application may also be referred to as a consultant tool.

The software application is directed to motivating behaviors that produce successful outcomes. An example of a successful outcome is to increase the volume of products sold by expanding the number of consultants that sell the product and the number of customers that buy them. Research has identified behaviors, that when implemented by existing consultants, make it likely that the successful outcomes will occur. Examples of these identified behaviors include creating the call scripts and email templates, making voice recordings of the call scripts, scheduling meetings with potential consultants and sales contacts, making telephone calls and sending emails to potential consultants and sales contacts and following-up on these telephone calls and emails, as well as other behaviors. The software application permits motivating, enabling and measuring these behaviors, as well as tracking the same. As a result, consultants that are exhibiting these behaviors can be encouraged to continue, and those that are not exhibiting these behaviors can be encouraged and motivated to exhibit the behaviors. The result is more, and more successful, sales consultants.

FIG. 1 shows an example system 100 that may be used with a consultant tool. The system 100 includes mobile electronic device 102, mobile electronic device 104, network 106, server computer 108 and database storage 110.

In some embodiments, the mobile electronic devices 102, 104 are smart telephones, such as iPhones. Other mobile electronic devices are used in other embodiments, such as a tablet computer, a laptop computer, a cellular phone, and the like. Network 106 is a network that provides remote access for mobile electronic devices 102, 104. Such a network may be the Internet, a wireless network for remote telephone communication or a combination of the two. Server computer 108 is a server computer that is located somewhere on network 106. In some examples, server computer 108 may be part of a server computer farm. Database storage 110 is a data base storage unit that can be accessed by server computer 108. More or fewer mobile electronic devices may be used. More than one server computer and/or database storage unit may be used.

As explained herein, the consultant tool on mobile electronic devices 102, 104 may be used to perform activities such as building contacts, editing call scripts, initiating phone calls to contacts, sending email messages to contacts, etc. When these activities are performed on mobile electronic devices 102, 104, messages are sent to server computer 108 via network 106 indicating that the activities occurred and providing sets of metadata describing various aspects of these activities. For example, server computer 108 is notified each time a client edits a call script, initiates a phone call to a client via the consultant tool and sends an email message to a contact via the consultant tool. Data contained in these messages may also be stored locally on mobile electronic devices 102, 104. Server computer 108 may store the notifications on server computer 108, on database storage 110 or on another server computer or database (not shown) that is accessible via network 106. As explained herein, activity information stored on server computer 108 and database storage 110 may be used to facilitate statistical analysis of consultant data. In addition, server computer 108 and database storage 110 stores backup information of contact and other data from mobile electronic devices 102, 104. As explained herein, the contact and other data is periodically synchronized between mobile electronic devices 102, 104 and with server computer 108 and database storage 110.

FIG. 2 shows an example sign-in screen 200 for the consultant tool. The sign-in screen 200 is displayed on mobile electronic device 102 when the consultant tool is activated on mobile electronic device 102. The sign-in screen 200 contains a field 202 for a user name and a field 204 for a password. When a user enters a valid user name and password, the user taps sign-in button 206 to sign-in to the consultant tool.

FIG. 3 shows an example home screen 300 for the software application. The home screen 300 is displayed when the user taps sign-in button 206 and is successfully recognized and authenticated. The home screen 300 includes a logout button 302 and a Consultant Tool button 304. The user taps the logout button 302 to logout of the consultant tool. The user taps the Consultant Tool button 304 to bring up a dashboard screen for the consultant tool.

FIG. 4 shows an example dashboard screen 400 for the consultant tool. The example dashboard screen 400 includes a Home button 402, a notifications area 404, a Build button 406, a Plan button 408, a Connect button 410 and a Train button 412. The user taps the Home button 402 to return to home screen 300. The notifications area 404 displays messages in support of user actions. The consultant tool displays the notifications as a way to encourage and support user activities, and particularly those behaviors that have been found to lead to the desired outcomes. For example, when the user adds a voice memo to a contact, a message similar to “Congrats, you added a voice memo to a contact” may be displayed in notifications area 404. As another example, when the user creates a script or a template, a message similar to “Great job, you created a script or template” may be displayed in notifications area 404. These and other notifications can be provided to encourage, motivate, and teach or remind the consultant of the behaviors that will lead him or her to success.

Tapping the Build button 406 causes a build home screen to be displayed. Tapping the Plan button 408 causes a planning home screen to be displayed. Tapping the Connect button 410 causes a connect home screen to be displayed and tapping the Train button 412 causes a training home screen to be displayed. The build, planning, connect and training home screens are explained later herein.

FIG. 5 shows an example build home screen 500. FIG. 5 also shows an expanded build screen 502. The build home screen 500 includes a Back button 504, an Import button 506, a Memory Jogger button 508, a contact information area 510, a More button 512, an Add Contact button 514 and an expanded contact information area 516. The Back button 504 permits the user to return to the dashboard screen 400. The Import button 506 permits the user to import contact information from the smart telephone address book and from the Facebook social networking website. Other sources for importing contact information are possible. The Memory Jogger button 508 causes words or phrases to be displayed that may remind the user of contacts the user may not have thought to add to the user's contact list.

The contact information area 510 permits the user to add contacts one at a time. For each contact, fields are provided for the first and last names of the contact, an email address for the contact, a cell phone number for the contact, and any notes the user wants to add about the contact. The Add Contact button 514 causes the contact information to be saved on the smart telephone, for example on mobile electronic device 102, and also to be sent to server computer 108 for storing, typically in a database such as database storage 110.

Tapping the More button 512 causes the expanded build screen 502 to be displayed. The expanded build screen 502 permits additional contact information to be added such as home and work telephone numbers for the contact, a city, state and zip code for the contact, a level of interest for the contact and an engagement status for the contact. Other contact information is possible. In some examples, the level of the interest may be low, medium or high. The engagement status provides a designation label for the contact. In some examples, the designation label may be consultant, PC or referral. A consultant label indicates the contact may be interested in becoming a consultant. The PC label indicates that the contact may be interested in becoming a preferred customer for sales, in other words a customer. The referral label indicates that the contact may be a source of referrals for other contacts.

FIG. 6 shows an example build screen 600 for selecting a source for importing contacts. The build screen 600 is displayed when the Import button 506 is tapped. The build screen 600 includes an Address Book button 602 and a Facebook button 604. The Address Book button 602 permits contacts to be imported into the consultant tool's contact list from the user's address book on the smart telephone. The Facebook button 604 permits contacts to be imported into the consultant tool's contact list from the Facebook social networking website.

FIG. 7 shows an example import contacts screen 700 for importing contacts from the user's address book on the user's smart telephone. The import contacts screen 700 is displayed when the user taps the Address Book button 602. The import contacts screen 700 shows that six example contacts were found in the user's address book on the user's smart telephone.

The import contacts screen 700 includes a Back button 702, a contacts area 704, an Add Selected button 706, a Done button 708 and a selection circle 710 for each contact. The Back button 702 causes a return to a previous display screen, in this case the build screen 600. The contacts area 704 displays a list of contacts from a selected import source. In the example contacts screen 700, the name of the contact is displayed and a photograph of the contact may also be displayed. In addition, a selection circle 710 is displayed to the left of each contact. Tapping a circle next to a contact selects the contact to be added to the user's contact list. For example, tapping the circle next to Bob Greenwood causes a checkmark to be displayed in the circle and indicates that Bob Greenwood is to be imported as a contact. Tapping the Add Selected button 706 or the Done button 708 imports all selected contacts to the user's contact list.

FIG. 8 shows an example connect home screen 800. The connect home screen 800 is displayed when the Connect button 410 is tapped on the dashboard screen 400 for the consultant tool. The connect home screen 800 includes a Back button 802, a Filter button 804, a search area 806, a contacts area 808 and a Delete button 810. The Back button 802 causes a return to the previous display screen, in this case to dashboard screen 400. The Filter button 804 permits a filtering of contacts by interest level, geographical location, engagement status and connection status, as explained later herein. The search area 806 permits a search for specific contacts. The contacts area 808 displays a current contact list. In the example connect screen 800, the name of the contact is displayed, a photograph of the contact may be displayed, and a label indicating the contact's interest level may be displayed. Each contact in the list may be deleted by swiping with a finger left or right on the contact's row. This action brings up the Delete button 810 for the swiped contact's row. Tapping on the Delete button 810 deletes the contact from the contact list.

FIG. 9 shows an example contact filter screen 900. The contact filter screen 900 is displayed when the Filter button 804 is tapped on the connect home screen 800. The contact filter screen 900 includes a set of Interest buttons 904, a City button 906, a State button 908, a set of Engagement buttons 910, a set of connection status buttons 912 and a search button 914. The Interest buttons permit the user to designate one or more interest levels of high, medium, low or unknown for filtering a contact search. The City button 906 and State button 908 permits the selection of a city and state, for filtering the contact search. The Engagement button 910 permits a selection of one or more engagement statuses of consultant, preferred customer, referral or unknown for filtering the contact search. As discussed earlier herein, a preferred customer is typically a customer designated for direct sales and a referral is a person who may be a source of referrals for other contacts. When one or more of an interest level, geographical location, engagement status and connection status is selected, the Search button 914 is tapped to initiate a search for contacts corresponding to the filter items entered. The search may be performed on the smart telephone, on server computer 108, on database storage 110 or on other server computers or other data storage systems.

FIG. 10 shows an example contact detail screen 1000 and an expanded contact detail screen 1002. The contact detail screen 1000 is displayed when a contact is selected on the connect home screen 800. The expanded contact detail screen 1002 is displayed when a More button (not shown in FIG. 10) is tapped on the contact detail screen 1000. The expanded contact detail screen 1002 has the same type of expanded contact information in the expanded contact information area 1020 as the expanded build screen 502.

The contact detail screen 1000 permits the user to communicate with a contact via phone call, email, or text message, optionally utilizing a call script for phone calls or an email template for emails. The contact detail screen 1000 includes a Back button 1004, a Call Prep button 1006, an Email Template button 1008, a Text button 1010, an Edit button 1012, a contact information area 1014, a voice memos area 1016, a new recording button 1018 and a History button 1022. The expanded contact detail screen 1002 includes an expanded contact information area 1020. The Call Prep button 1006, Email Template button 1008, Text button 1010 and History button 1022 are explained in the following paragraphs. The Edit button 1012 permits information in the contact information area 1014 and expanded contact information area 1020 to be edited.

The History button 1022 permits the user to view a list of contact interactions such as calling, emailing or sending texts through the consultant tool. As the user interacts with a contact, the consultant tool keeps track of each interaction and displays a row on the contact detail screen 1000 for each interaction. Each row may list a time and date for each interaction and may include an icon representing the type of interaction, for example a phone call or an email sent. The rows are displayed below the History button 1022, as shown in display screen area 1024.

FIG. 11 shows an example call prep screen 1100. The call prep screen 1100 is displayed when the Call Prep button 1006 is tapped. The call prep screen 1100 permits the user to select and edit a script for calling a contact. The call prep screen 1100 includes a Back button 1102, an Invite Button 1104, a Follow-up button 1106, a Close button 1108, a script list area 1110, a selection circle 1112 for each script in the script list and a Select Template button 1114. When the Back button 1102 is tapped, a previous screen is displayed, in this case contact detail screen 1000. Tapping the Invite Button 1104, Follow-up button 1106 or Close button 1108 causes a corresponding listing of call scripts in the category that corresponds to the tapped button to be displayed in the script list area 1110. For example, when the Invite Button 1104 is tapped, call scripts related to inviting contacts to some type of engagement are listed. When the Follow-up button 1106 is tapped, call scripts related to following-up on a previous engagement are listed. When the Close button 1108 is tapped, call scripts related to closing a contact are listed. Closing a contact relates to making a final pitch to the contact that hopefully will convince the contact to become a consultant who sells or a customer who buys products, as the case may be.

The call scripts displayed in the script list area 1110 are edited call scripts obtained from the user's library of edited call scripts. A discussion of call scripts is provided later in this disclosure. Each listed call script has a selection circle 1112 to the left of the title of the call script on a row in which the call script is displayed. To select a call script, the user taps on the row in which the call script is displayed. This action causes a checkmark to be displayed in the circle on the tapped row, as shown in the example in FIG. 11. The user then taps the Select Template button 1114 to select the selected template.

FIG. 12 shows another example call preparation screen 1200. The call preparation screen 1200 provides an edited call script from which the user can practice a telephone call before actually making the telephone call. The call preparation screen 1200 includes a Back button 1202, a name and optionally a photo 1204 of the person to be called, the edited call script 1206 and buttons corresponding to each phone number associated with the selected contact, in the example in FIG. 12, a Cell button 1208 and a Home button 1210. When the Back button 1202 is tapped, a previous screen is displayed, in this case the call prep screen 1100. The user can review the edited call script 1206, preferably by reciting the call script out loud, as practice before making the telephone call. Tapping one of the phone number buttons initiates a telephone call to the phone number associated with the tapped button. For example, in the example in FIG. 12, the Cell button 1208 would initiate a telephone call to the cell phone number of the person to be called while tapping the Home button 1210 would initiate a telephone call to the home phone number of the person to be called.

FIG. 13 shows an example email template screen 1300. The email template screen 1300 is displayed when the Email template button 1008 is tapped. The email template screen 1300 permits the user to select and edit a template for emailing a contact. The email template screen 1300 includes a Back button 1302, an Invite Button 1304, a Follow-up button 1306, a Close button 1308, an email template list area 1310, a selection circle 1312 for each template in the template list and a Select Template button 1314. When the Back button 1302 is tapped, a previous screen is displayed, in this case contact detail screen 1000. The Invite Button 1304, Follow-up button 1306 and Close button 1308 cause a corresponding listing of email templates in the category that corresponds to the tapped button to be displayed in the email template list area 1310. For example, when the Invite Button 1304 is tapped, email templates related to inviting contacts to some type of engagement are displayed. When the Follow-up button 1106 is tapped, email templates related to following-up on a previous engagement are displayed. When the Close button 1108 is tapped, email templates related to closing a contact are displayed. Closing a contact relates to making a final pitch to the contact that hopefully will convince the contact to become a consultant who sells or a customer who buys products, as the case may be.

Each listed email template has a selection circle 1312 to the left of the title of the email template on a row in which the email template is displayed. To select an email template, the user taps on the row in which the email template is displayed. This action causes a checkmark to be displayed in the circle on the tapped row, as shown in the example in FIG. 13. The user then taps the Select Template button 1314 to select the selected template.

FIG. 14 shows an example planning calendar screen 1400. The planning calendar screen 1400 is displayed when the Plan button 408 is tapped on the dashboard screen 400. The planning calendar provides calendar views in a list view or a month view and a Today button to update the current view to display the current day. The month view is shown in FIG. 14. In the month view shown, days on which corporate-sponsored events are scheduled are indicated by small circles under the day in which the events are to occur. For example, circles 1404 and 1406 indicate that corporate-sponsored events are scheduled for Oct. 8, 2013 and Oct. 29, 2013, respectively. A corporate-sponsored event is one of various types of events planned and organized by the corporate direct selling company. Additional events can be added to the planning calendar screen 1400 by tapping the Add new event button 1408. The Back button 1402 returns the display to a previous screen, in this case to dashboard screen 400.

FIG. 15 shows an example list view 1500 of the planning calendar screen 1400. The list view 1500 shows example events 1512 scheduled for Wednesday, Feb. 13, 2013. The events include a haircut appointment, a team meeting, a business presentation and a groundswell. Events for previous days can be listed by tapping the left arrow button 1506 and events for future days can be listed by tapping the right arrow button 1508. In addition, specific events can be searched for via search box 1504. A Back button 1502 permits the display of a previous screen, in this case the planning calendar screen 1400.

FIG. 16 shows an example training screen 1600. The training screen 1600 is displayed when the Train button 412 is tapped on the dashboard screen 400. The training screen 1600 permits a user to view text-based tutorials, listen to audio tutorials and view video tutorials relating to different aspects of direct selling and recruiting new consultants. The training screen 1600 includes a Back button 1602, an Invite button 1604, a Follow-up button 1606, a Close button 1608, a Tutorial button 1610, a My Library button 1612, a Share button 1614, a training list area 1616, a Create My Own button 1618 and a Feedback button 1620. In other embodiments, the training screen 1600 may have a different format. For example, the training screen 1600 may permit a user to directly access a getting started user interface, a call scripts user interface, an email templates user interface, a my library user interface and a help user interface. Other formats for the training screen 1600 are possible.

Tapping the Tutorial button 1610 displays a description of training resources provided by the consultant tool. Tapping the Invite button 1604 after the Tutorial button 1610 is tapped displays a description of training resources related to invitations. Tapping the Follow-up button 1606 after the Tutorial button 1610 is tapped displays a description of training resources related to follow-ups. Tapping the Close button 1608 after the Tutorial button 1610 is tapped displays a description of training resources related to closing. For example, when the Invite button 1604 is tapped after the Tutorial button 1610 is tapped, training resources related to invitations are displayed in the training list area 1616. In this example, the training resources include a getting started checklist, a tutorial for overcoming objections, a tutorial for crafting a short story and a video overview.

The getting started checklist permits the user to track progress on critical behaviors associated with the consulting tool. Example critical behaviors include adding or importing contacts; recording and sharing a short story; editing and customizing a call script; calling and inviting a contact to an event; and scheduling an event with a contact. Other critical behaviors are possible. Selecting the getting started checklist displays a getting started screen (not shown) on the user interface. The getting started screen may include a row for each critical behavior and may also include a completion circle for each critical behavior. When a critical behavior is completed, the completion circle is replaced by a checkmark.

Tapping the My Library button 1612 provides a display of training resources that the user has created. These training resources may be filtered by invitations, follow-ups and closings by tapping the Invite button 1604, the Follow-up button 1606 and the Close button 1608, respectively. Tapping the Share button 1614 permits the user to select listed training resources from the user's library that the user may want to share with the user's sponsor or with other members of the user's team. Tapping the Create My Own button 1618 permits the user to create the user's own scripts, templates and voice recordings. Tapping the Feedback button 1620 permits the user to send feedback about the consultant tool. Tapping the Back button 1602 reverts to a previous display.

FIG. 17 shows an example editing screen 1700 for text-based training resources. The editing screen 1700 is displayed when a text-based resource in the training list area 1616 of the Tutorial 1610 or My Library 1612 views is tapped. In the example displayed in FIG. 17, a call script has been selected for editing after the Tutorial button 1610 was tapped and the Invite button 1604 was tapped. The editing screen 1700 shows the title 1704 of the selected resource. In the example displayed in FIG. 17, the title 1704 is Call Script—Invite. The user can edit the call script, including its title 1704, and then tap the Save To My Library button 1706 to save the edited call script to the user's library. Resources related to inviting, following up and closing may be edited by tapping the Invite button 1604, Follow-up button 1606 and the Close button 1608, respectively.

As stated, tapping the Share button 1614 permits the user to select listed training resources from the user's library for sharing with the user's sponsor or with other members of the user's team. Because items are shared from the user's library, the Share button 1614 is only enabled when the My Library button 1612 is tapped. When the Share button 1614 is enabled, a selection circle (not shown) appears next to each item in the user's library. For example, a circle would appear next to each item listed in training list area 1616 for the user's library. When an item is tapped, a checkmark appears in the selection circle for the tapped item. Tapping the Share button 1614 after one or more items have been selected results in the check marked item(s) being shared.

FIG. 18 shows an example create my own screen 1800. The create my own screen 1800 is displayed when the Create My Own button 1618 is tapped. The create my own screen 1800 permits the user to create a voice recording, call script or email template for inviting, following up, or closing. The create my own screen 1800 includes a Back button 1802, a Name field 1804, a first selection field 1806, a second selection field 1808 and a Get Started button. A name for the item to be created must be entered in the Name field 1804. The first selection field 1806 permits selection of whether to create a voice recording, a call script or an email template. Tapping at the right side of the first selection field 1806 displays a scroll mechanism from which either a voice recording, call script or email template may be selected. The second selection field 1808 permits selection of the goal for the item selected in the first selection field 1806, either inviting, following up or closing. Tapping at the right side of the second selection field 1808 displays a scroll mechanism from which either inviting, following up or closing may be selected. After selections have been made for the first selection field 1806 and the second selection field 1808 and after a name has been entered in the Name field 1804, the Get Started button 1810 is tapped.

FIG. 19 shows an example create my own screen 1900. The create my own screen 1900 is displayed after the Get Started button 1810 is tapped when the first selection field 1806 indicates a call script or an email template. The example in FIG. 19 further indicates that the first selection field 1806 was selected to be call script and the second selection field 1808 was selected to be following-up. The create my own screen 1900 includes a Back button 1902, a name field 1904, an editing area 1906 and a Save To My Library button 1908. In the example in FIG. 19, the name field 1904 shows the name of the resource is currently set to “Follow-up”. The user may edit the name that appears in the name field 1904. The editing area 1906 permits the user to create and edit the text of the call script. After the user has completed creating and editing the call script, the user can tap the Save to My Library button to save the call script in the user's library. When the first selection field 1806 is selected to be the email template, the editing area 1906 permits the user to create and edit the text of the email template. After the user has completed creating and editing the email template, the user can tap the Save to My Library button to save the call script in the user's library.

FIG. 20 shows an example create my own screen 2000 for a voice recording follow-up. The create my own screen 2000 is displayed after the Get Started button 1810 is tapped when the first selection field 1806 indicates a voice recording and when the second selection field 1808 indicates a follow-up. The create my own screen 2000 permits the user to record and save a voice recording. The create my own screen 2000 includes a Back button 2002, a recording length display area 2004, a Record button 2006, a Save button 2008 and a Start Over button 2010. The user taps the Record button 2006 to start a recording. After the Record button 2006 is tapped, the Record button 2006 changes into a Pause button 2006 (not shown). As the user speaks into the smart telephone, the recording length display area 2004 indicates how long the user has been talking. The user can tap the Pause button 2006 to stop recording. When paused the Pause button 2006 changes back to the Record button 2006. The user can either resume recording by tapping the Record button 2006 again, start over by tapping the Start Over button 2010 or save the recording to the user's library by tapping the Save button 2008. Once saved, the recording will appear in the My Library section of the training screen 1600.

FIG. 21 shows an example activity report 2100. The activity report represents a way in which data from the consultant tool can be used to help evaluate the performance of consultants, such as to permit the motivating, enabling and measuring of behaviors that will lead to success for the sales consultants. For example, the report allows a viewer of the report to see how the consultants are doing, and permits the viewer to praise those that exhibit the proper behavior and train, educate, or encourage those that are not, to direct them to the proper behavior.

As discussed, records of specific consultant activities are sent from the smart telephone of the consultant to a server computer 108 connected via network 106. Specific consultant activities that are included in the report include building contacts, creating call scripts and email templates, making calls and emails to prospective consultants and customers, making voice recordings, etc. Other consultant activities may be included.

The activity report 2100 shows an activity summary for five consultants for the week of Dec. 3, 2012 through Dec. 9, 2012. The activity report 2100 includes columns for the consultant's name 2104 and for activity summaries relating to building contacts 2106, connecting to contacts 2108, planning 2110 and training 2112. A time field 2102 shows a time frame for the report. As shown in FIG. 21, activity summaries under building contacts 2106 includes the total number of contacts for each consultant and the number of contacts added during the current period. Activity summaries for connecting to contacts 2108 include totals for invitations issued, telephone calls made, emails sent and text messages sent for each consultant. Activity summaries for planning 2110 include totals for follow-ups during the current period and follow-ups that are scheduled. Activity summaries for training 2112 include the number of call scripts created, email templates created and voice recordings made during the current period. Summaries of other activities are possible.

FIG. 22 shows an example data schema for the consultant tool. The data schema is stored on a server computer or database accessible via network 106. For example, the data schema may be stored on server computer 108 or on database storage 110. The schema shows data fields being stored and relationships between the data fields. Some example data fields that are monitored and stored include users, locations, notifications, contacts, contact phone numbers and email addresses, events, recordings, templates and user settings. Other data fields may be stored and monitored.

FIG. 23 illustrates example physical components of the mobile electronic device 102, 104. As illustrated in the example of FIG. 23, the mobile electronic device 102, 104 includes at least one central processing unit (“CPU”) 2302, a system memory 2308, and a system bus 2322 that couples the system memory 2308 to the CPU 2302. The system memory 2308 includes a random access memory (“RAM”) 2310 and a read-only memory (“ROM”) 2312. A basic input/output system contains the basic routines that help to transfer information between elements within the mobile electronic device 102, 104, such as during startup, is stored in the ROM 2312. The mobile electronic device 102, 104 further includes a mass storage device 2314. The mass storage device 2314 is able to store software instructions and data.

The mass storage device 2314 is connected to the CPU 2302 through a mass storage controller (not shown) connected to the bus 2322. The mass storage device 2314 and its associated computer-readable data storage media provide non-volatile, non-transitory storage for the Mobile electronic device 102, 104. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the mobile electronic device 102, 104.

According to various embodiments of the invention, the mobile electronic device 102, 104 may operate in a networked environment using logical connections to remote network devices through the network 2320, such as a local network, the Internet, or another type of network. The mobile electronic device 102, 104 may connect to the network 2320 through a network interface unit 2304 connected to the bus 2322. It should be appreciated that the network interface unit 2304 may also be utilized to connect to other types of networks and remote computing systems. The mobile electronic device 102, 104 also includes an input/output controller 2306 for receiving and processing input from a number of other devices, including a keyboard, a mouse, a touch user interface display screen, or another type of input device. Similarly, the input/output controller 2306 may provide output to a touch user interface display screen, a printer, or other type of output device.

As mentioned briefly above, the mass storage device 2314 and the RAM 2310 of the mobile electronic device 102, 104 can store software instructions and data. The software instructions include an operating system 2318 suitable for controlling the operation of the mobile electronic device 102, 104. The mass storage device 2314 and/or the RAM 2310 also store software instructions, that when executed by the CPU 2302, cause the mobile electronic device 102, 104 to provide the functionality of the mobile electronic device 102, 104 discussed in this document. For example, the mass storage device 2314 and/or the RAM 2310 can store software instructions that, when executed by the CPU 2302, cause the mobile electronic device 102, 104 to display received physiological data on the display screen of the mobile electronic device 102, 104.

Other example physical components of the mobile electronic device 102, 104 are possible. In general, the mobile electronic device 102, 104 supports a computing platform that provides capabilities for a standardized interface (for example USB) to retrieve data from specialized sensors, a standardized network communication interface (for example WiFi), a standardized wireless communication interface (for example Bluetooth or NFC) and a user interface.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer-readable storage memory comprising instructions that, when executed by a mobile electronic computing device, cause the mobile electronic computing device to:
receive and store contact information for a plurality of business contacts;
display one or more editable call scripts and one or more editable email templates;
receive edits to one or more of the call scripts or one or more of the email templates or receive one or more new call scripts or email templates;
send the one or more edited or new call scripts or the one or more edited or new email templates to a third party;
initiate communications to one or more of the business contacts using the one or more editable, edited or new call scripts or the one or more editable, edited or new email templates; and
send a record of the communications to a server computer.

2. The computer-readable storage memory of claim 1, wherein the instructions further cause the mobile electronic computing device to import business contact information from an address book on the mobile electronic computing electronic device and from a contact list from a social networking website.

3. The computer-readable storage memory of claim 1, wherein the instructions further cause the mobile electronic computing device to display a memory jogger list, the memory jogger list including a plurality of words and phrases that may help recall names of business contacts.

4. The computer-readable storage memory of claim 1, wherein the instructions further cause the mobile electronic computing device to provide a filter that can be used to filter the business contacts by city and state.

5. The computer-readable storage memory of claim 1, wherein the instructions further cause the mobile electronic computing device to display a call preparation screen, the call preparation screen permitting a user to select one or more of the editable, edited or new call scripts for an invitation telephone call to extend an invitation to a business contact, a follow-up telephone call to follow-up on a previous call to the business contact and a closing telephone call to finalize a business transaction with the business contact.

6. The computer-readable storage memory of claim 1, wherein the instructions further cause the mobile electronic computing device to display an email template screen, the email template screen permitting a user to select one or more of the email templates for an email to extend an invitation to a business contact, a follow-up email to follow-up on a previous interaction with the business contact and a closing email to finalize a business transaction with the business contact.

7. The computer-readable storage memory of claim 1, wherein the instructions further cause the mobile electronic computing device to display a training screen for viewing and editing one or more of the editable, edited or new call scripts or email templates.

8. The computer-readable storage memory of claim 7, wherein the instructions further cause the mobile electronic computing device to select from the training screen one more editable, edited or new call scripts or email templates related to invitation telephone calls or emails, follow-up telephone calls or emails and closing telephone calls or emails.

9. The computer-readable storage memory of claim 1, wherein the instructions further cause the mobile electronic computing device to permit saving edited and new call scripts and email templates to a user library on the mobile electronic computing device.

10. The computer-readable storage memory of claim 9, wherein the instructions further cause the mobile electronic computing device to permit the edited and new call scripts and email templates to be shared with the third party after the call scripts and email templates are saved in the user library.

11. The computer-readable storage memory of claim 1, wherein the instructions further cause the mobile electronic computing device to permit a voice recording to be made, wherein the voice recording is saved on the mobile electronic computing device.

12. The computer-readable storage memory of claim 1, wherein the instructions further cause the mobile electronic computing device to display notifications on the mobile electronic computing device, the notifications comprising messages in support of user actions.

13. The computer-readable storage memory of claim 1, wherein the instructions further cause the mobile electronic computing device to back up data on the mobile electronic computing device by periodically sending business contact and edited and new call script and email template data saved on the mobile electronic computing device to the server computer.

14. The computer-readable storage memory of claim 1, wherein the instructions further cause the mobile electronic computing device to display a first calendar on the mobile electronic computing device, data displayed on the first calendar being synchronized with data from a second calendar that is installed on the mobile electronic computing device.

15. The computer-readable storage memory of claim 1, wherein the instructions further cause the mobile electronic computing device to automatically synchronize data with the server computer.

16. A method implemented on a server computer, the method comprising:
on the server computer, receiving business contact information from a mobile electronic computing device;
receiving, from the mobile electronic computing device, information of call scripts created and email templates created on the mobile electronic computing device;
receiving, from the mobile electronic computing device, information of telephone calls made, email messages sent and text messages sent to business contacts from the mobile electronic computing device; and
compiling one or more activity reports of the business contact information, call scripts created, email templates created, telephone calls made, email messages sent and text messages sent to business contacts from the mobile electronic computing device.

17. The method of claim 16, wherein the one or more activity reports provide a breakdown of business contacts added, call scripts created, email templates created, telephone calls made, email messages sent and text messages sent for each individual who added the business contacts, created the call scripts, created the email templates, made the telephone calls, sent the email messages and sent the text messages.

18. The method of claim 16, further comprising storing in a database the business contact information and records of the call scripts created, email templates created, telephone calls made, email templates sent and text messages sent.

19. The method of claim 18 further comprising using the business contact information and records of the call scripts created, email templates created, telephone calls made, email templates sent and text messages sent to identify top performing employees.

20. A method implemented in a software application running on a mobile electronic computing device, the method comprising:
on the mobile electronic computing device, receiving and storing contact information for a plurality of business contacts;
displaying one or more editable call scripts and one or more editable email templates;
receiving edits to one or more of the call scripts or one or more of the email templates or receiving one or more new call scripts or email templates;
sending the one or more edited or new call scripts or the one or more edited or new email templates to a third party;
initiating communications to one or more of the business contacts using the one or more editable, edited or new call scripts or the one or more editable, edited or new email templates; and
sending a record of the communications to a server computer.
